(19) United States
(12) Patent Application Publication
(10) Pub. No.: US 2025/0104363 A1
(43) Pub. Date: Mar. 27, 2025

(54) Non-User Controls for an Artificial Reality Device

(71) Applicant: Meta Platforms Technologies, LLC, Menlo Park, CA (US)

(72) Inventors: Alexander FAABORG, Mountain View, CA (US); Nicholas Ferianc KAMUDA, Seattle, WA (US); Philippe PAREIN, Antwerpen (BE); Katharina Huong Giang TRAN PHUC, London (GB)

(21) Appl. No.: 18/474,660

(22) Filed: Sep. 26, 2023

(51) Int. Cl. G06T 19/00; G06T 5/00

(52) U.S. Cl. CPC G06T 19/006; G06T 5/70; G06T 5/77

(57) ABSTRACT

Artificial reality (XR) devices can recognize and capture many aspects of the real world around the user, including non-users. Some implementations can recognize gestures and commands from users other than the XR device user (“non-users”), and execute actions in response. Some implementations can track hand and body movement of non-users around the XR device, and can trigger an action when a certain position or pose is recognized (e.g., waving the arms in front of the user). The action can be, for example, activating pass-through for the non-user, activating pass-through for an area designated by the non-user, excluding capture of images of certain non-users who have opted out, etc. In some implementations, non-users opting out of capture can be blurred out or in-painted, while in other implementations, the XR device can capture images when such non-users are absent from the frame.

### TECHNICAL FIELD

The present disclosure is directed to providing non-user controls for an artificial reality (XR) device.

### BACKGROUND

Artificial reality (XR) devices are becoming more prevalent. As they become more popular, the applications implemented on such devices are becoming more sophisticated. Mixed reality (MR) and augmented reality (AR) applications can provide interactive 3D experiences that combine images of the real-world with virtual objects, while virtual reality (VR) applications can provide an entirely self-contained 3D computer environment. For example, an MR or AR application can be used to superimpose virtual objects over a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR (together XR) experiences can be observed by a user through a head-mounted display (HMD), such as glasses or a headset. An MR HMD can have a pass-through display, which allows light from the real-world to pass through a lens to combine with light from a waveguide that simultaneously emits light from a projector in the MR HMD, allowing the MR HMD to present virtual objects intermixed with real objects the user can actually see.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for controlling an artificial reality (XR) device by a non-user of the XR device.

FIG. 6A is a conceptual diagram illustrating an example view on an artificial reality (XR) device of a virtual reality (VR) experience.

FIG. 6B is a conceptual diagram illustrating an example view, from a position of an artificial reality (XR) device, of a non-user making a pose mapped to activation of pass-through for the non-user on the XR device.

FIG. 6C is a conceptual diagram illustrating an example view on an artificial reality (XR) device of a non-user being displayed in pass-through in response to an identified pose of the non-user.

FIG. 6D is a conceptual diagram illustrating an example view, from a position of an artificial reality (XR) device, of a non-user making a pose mapped to activation of pass-through for a real-world object on the XR device.

FIG. 6E is a conceptual diagram illustrating an example view on an artificial reality (XR) device of a real-world object being displayed in pass-through in response to an identified pose of a non-user.

FIG. 7 is a flow diagram illustrating a process used in some implementations for obscuring a non-user in a data stream of one or more images.

FIG. 8 is a conceptual diagram illustrating an example view on an artificial reality (XR) device of a non-user being obscured based on an image capture opt-out process by the non-user.

FIG. 9 is a conceptual diagram illustrating an exemplary flow for non-user facial recognition according to some implementations of the present technology.

The techniques introduced here may be better understood by referring to the following Detailed Description in conjunction with the accompanying drawings, in which like reference numerals indicate identical or functionally similar elements.

### DETAILED DESCRIPTION

Artificial reality (XR) devices can recognize and capture many aspects of the real world around the user, including non-users (e.g., other people or objects within the field-of-view of the XR device that are not in possession of the XR device). Some implementations can recognize gestures and commands from people other than the XR device user, and execute actions in response. Some implementations can track hand and body movement of non-users around the XR device, and can trigger an action when a certain position or pose is recognized (e.g., waving the arms in front of the user). In some examples, the position or pose can be accompanied by an audible announcement by the non-user. The action can be, for example, activating pass-through for the non-user, and/or activating pass-through for an area designated by the non-user.

For example, a user of an XR device can be playing a fully immersive, computer-generated virtual reality (VR) game obscuring her real-world surroundings. A non-user, whom the XR device user cannot see, can approach the XR device, wave his hand, and speak her name. The waving gesture can be captured by the XR device's camera, while the spoken name can be captured by the XR device's microphone. The XR device can process the images, the audio to identify the gesture and/or the name being spoken, and access a mapping of non-user actions to commands. In this example, a waving gesture accompanied by a spoken name of the XR device user can be mapped to activating pass-through for the non-user. The XR device can then execute the command, such that the user of the XR device can see the non-user in pass-through. In some implementations, the pass-through is selective such that the XR device user views the non-user in pass-through while viewing the VR game on the remaining portions of the display.

In another example, some implementations can either A) exclude capture of images of certain non-users who have opted out, or B) capture images of non-users in response to the non-users having opted in. In some implementations, this “opt in”/“opt out” process can be accomplished via a pre-registration (e.g., via a social media platform), by the user making a particular gesture (e.g., covering his face or giving a thumbs up), or saying a particular phrase (e.g., “Don't take my picture!”). In some implementations, non-users opting out of capture can be blurred out or in-painted, while in other implementations, the XR device can be limited to capturing images when such non-users are absent from the frame.

For example, a user wearing mixed reality (MR) glasses can attend a social function with a number of other people. The MR glasses can scan the real-world environment as the user traverses the social function, capturing images of non-users (who may or may not also be wearing MR glasses or other XR devices). The MR glasses can perform facial recognition on the other people being captured, and access images of known social connections (e.g., via a social media platform) to identify the non-users. Once identified, the MR glasses can determine whether the non-users have opted into or out of being captured by the MR glasses (e.g., via preregistration on the social media platform). In one example, the MR glasses can only capture images of non-users that have opted in and/or cease capturing images when the MR glasses recognize one or more non-users in its field of view that have opted out. In another example, the MR glasses can continue capturing images, but can obscure the non-users that have opted out when displaying and/or storing the images. In still another example, the MR glasses can continue capturing images until or unless one or more non-users opt out in real time, e.g., by announcing that they do not want to be included, by making a particular gesture (e.g., by covering their faces), etc.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Aspects of the present disclosure provide specific technological improvements in the technical field of artificial reality. Traditionally, non-users of an XR device have limited or no control over the functions on the XR device. Thus, in conventional virtual reality (VR) experiences for example, the non-user has no means to make himself visible, or to interact with the XR device, its functions, and/or its user. Some implementations provide for seamless control of an XR device by a non-user via particular gestures and/or audible announcements detectable by the XR device. For example, the non-user can cause the XR device to stop capturing and/or storing images of him, protecting the privacy of the non-user and conserving processing and power resources on the XR device. In addition, in some implementations, the XR device can capture and store images in response to a non-user making a detected “opt in” gesture, conserving storage space on the XR device. In another example, the non-user can cause the XR device to establish a communication link with the non-user's device, such that the XR device can share its view or other content with the non-user, and vice versa.

In still another example, the non-user can cause the XR device to activate partial pass-through in a VR experience, allowing the non-user (or an object or area indicated by the non-user) to be seen. Thus, the non-user can interact with the XR device's user without the user having to exit the VR experience or remove the XR device (e.g., an XR HMD). In this example, the user can continue the VR experience while also seeing the non-user. In other words, some implementations can allow a user to multitask while enjoying the VR experience.

In still another example, a streamlined communication channel can be triggered in response to non-user poses, gestures, etc. that permits content sharing between the user's XR device and a non-user's computing device. Reducing the friction points in such a communication can increase the social interactions between XR device users and non-users. Further, a non-user's real-world motion (e.g., poses, gestures, etc.) can trigger the device interaction between the user's XR device and the non-user's non-XR device, thus permitting a non-user to benefit from the enhanced functionality of the XR device. Further, by not requiring that the VR experience be fully rendered on the XR device and instead activating partial pass-through (and when not desired or necessary), compute resources can be conserved, such as processing power, battery power, display resources, etc. as in some cases computing the virtual objects for the VR experience is more resource intensive than rendering the captured video of the real-worl for that portion of the display. Such resources can therefore be allocated to performing other fundamental and necessary tasks on the XR device, thereby improving processing speed and latency.

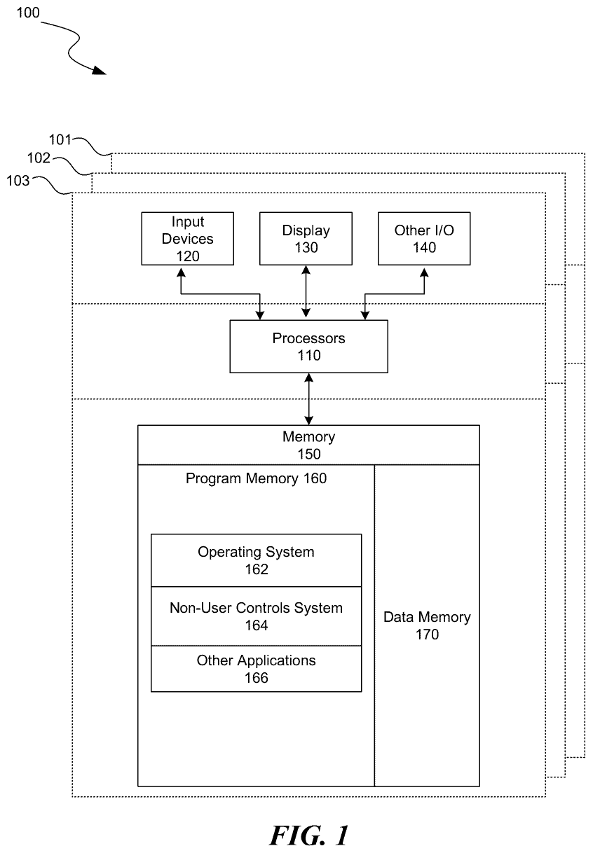

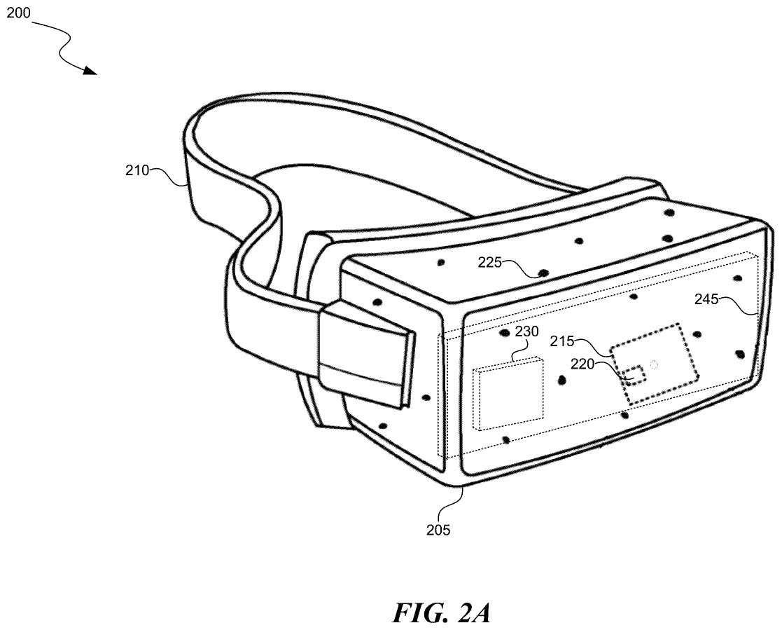

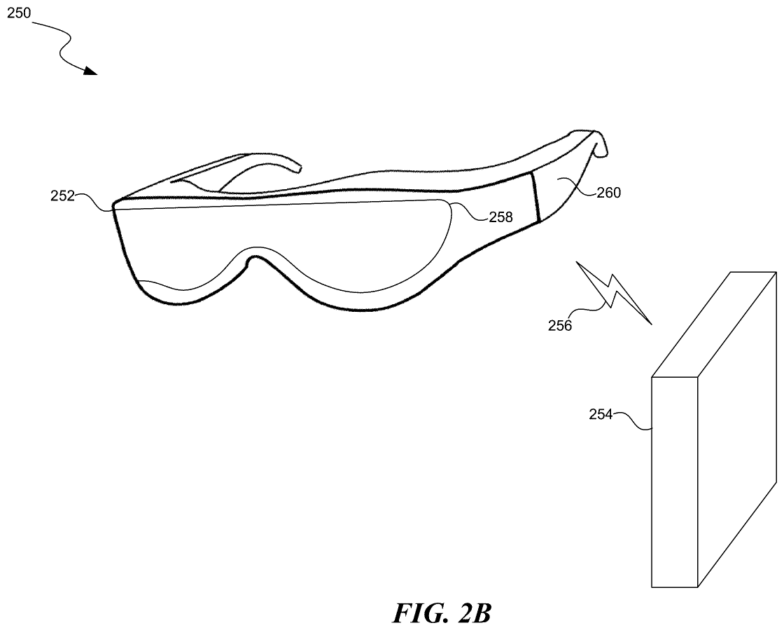

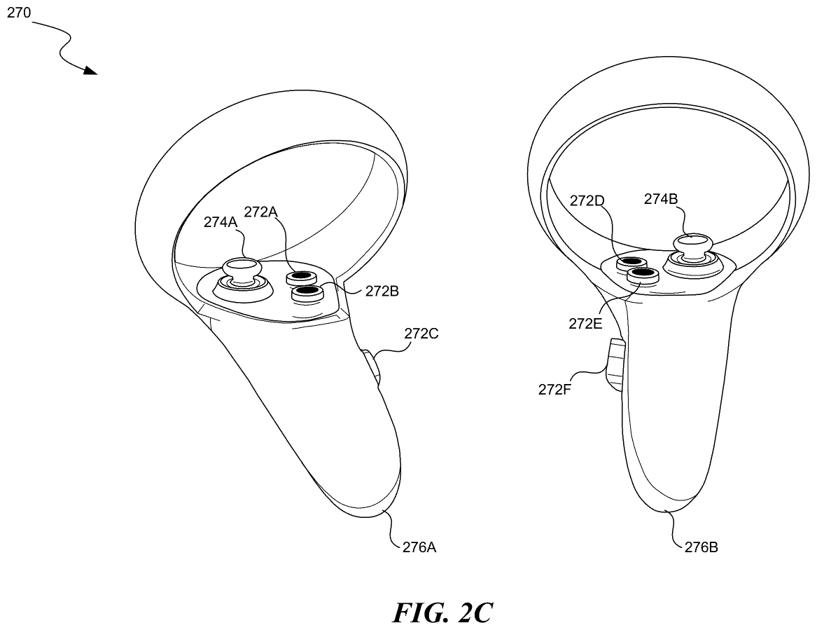

Several implementations are discussed below in more detail in reference to the figures. FIG. 1 is a block diagram illustrating an overview of devices on which some implementations of the disclosed technology can operate. The devices can comprise hardware components of a computing system 100 that can control an artificial reality (XR) device by a non-user of the XR device. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, non-user controls system 164, and other application programs 166. Memory 150 can also include data memory 170 that can include, e.g., content data, rendering data, image data, non-user identification data, pose data, action data, mapping data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

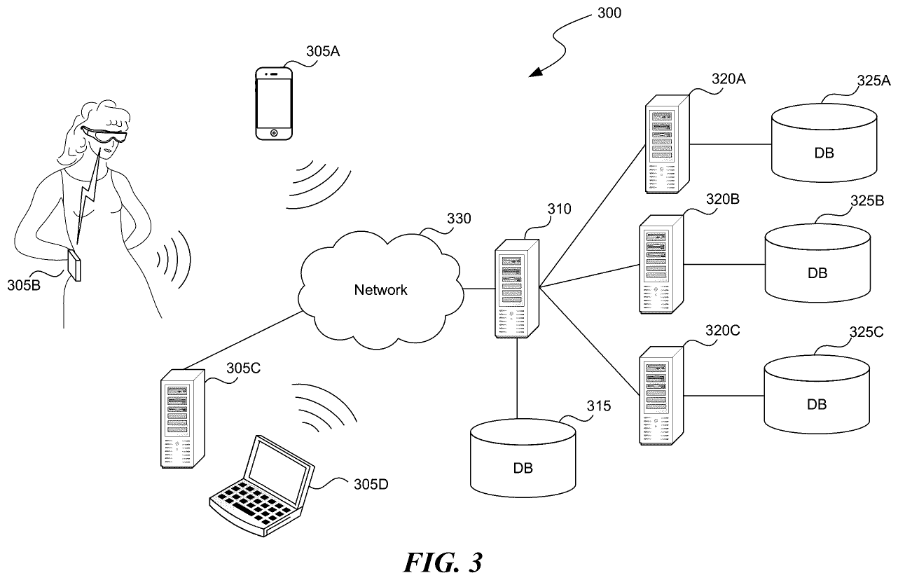

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

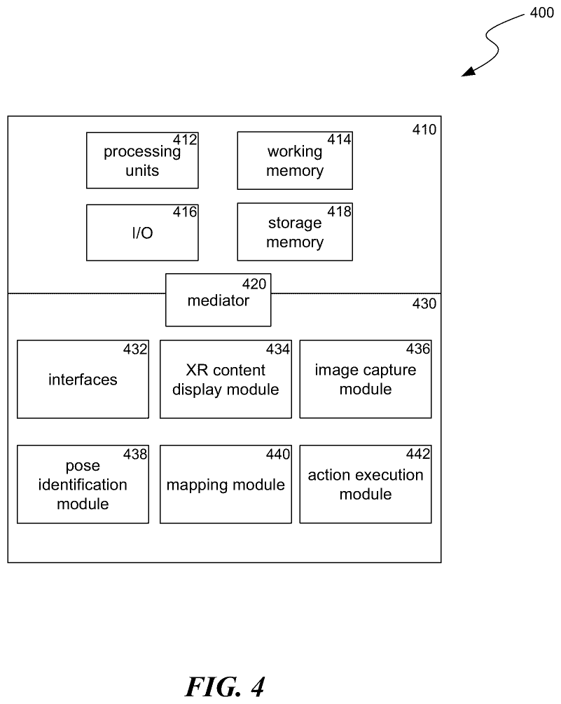

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

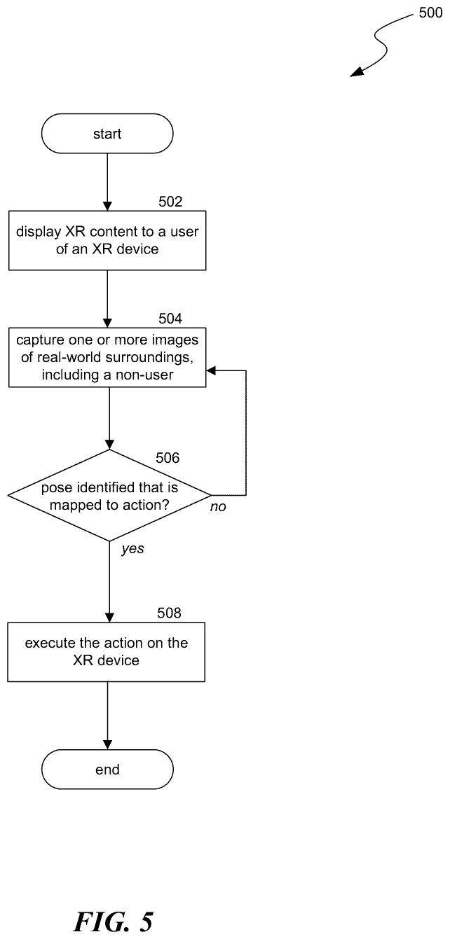

Specialized components 430 can include software or hardware configured to perform operations for controlling an artificial reality (XR) device by a non-user of the XR device. Specialized components 430 can include XR content display module 434, image capture module 436, pose identification module 438, mapping module 440, action execution module 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications. In some implementations, specialized components 430 can be included in non-user controls system 164 of FIG. 1. In some implementations, specialized components 430 can execute process 500 of FIG. 5.

XR content display module 434 can display XR content to a user of the XR device. In some implementations, XR content display module 434 can display a fully immersive, three-dimensional (3D), fully computer-generated environment, such as in virtual reality (VR). In some implementations, XR content display module 434 can display one or more virtual objects overlaid on a view of a real-world environment surrounding the XR device, such as in mixed reality (MR) or augmented reality (AR). Although described herein as including XR content display module 434, it is contemplated that, in some implementations, XR content display module 434 can be omitted, such as when the XR device captures, but does not display content. Further details regarding displaying XR content to a user of an XR device are described herein with respect to block 502 of FIG. 5.

Image capture module 436 can capture one or more images of real-world surroundings of the XR device. Image capture module 436 can capture the one or more images using one or more cameras that can, for example, be included in input/output devices 416. The one or more images can capture one or more non-users of the XR device, e.g., other people in view of the user of the XR device, who may or may not also be using an XR device. In some implementations, the non-users can be using other devices, such as mobile devices, tablets, computing devices, communication devices, etc. Further details regarding capturing images of real-world surroundings of an XR device, including images of non-users, are described herein with respect to block 504 of FIG. 5.

Pose identification module 438 can identify a pose of a non-user in the one or more images captured by image capture module 436. In some implementations, pose identification module 438 can map the detected body parts of the non-user to a kinematic model, and track the movements of the non-user as applied to the model to identify a pose made by the non-user. In some implementations, pose identification module 438 can identify the pose of the non-user by applying object recognition and/or object detection techniques to the one or more images. The machine learning model can be trained, for example, on images of known body arts (e.g., arms, hands, fingers, etc.), thereby allowing pose identification module 438 to identify particular body parts. Further, in some implementations, the machine learning model can be trained on images of non-users making known gestures in front of the XR device. By comparing the features of identified body parts of the non-user to the training data, pose identification module 438 can predict, to some degree of certainty, the pose made by the non-user. In some implementations, pose identification module 438 can alternatively or additionally identify a non-user utterance (e.g., a verbal statement) via audio captured by one or more microphones included in input/output devices 416. Further details regarding identifying a pose of a non-user in one or more images are described herein with respect to block 506 of FIG. 5.

Mapping module 440 can correlate poses and/or non-user utterances to particular actions on the XR device. For example, mapping module 440 can correlate poses, identified by pose identification module 438, to particular actions on the XR device. In some implementations, mapping module 440 can maintain a look-up table of poses/utterances mapped to available actions. Mapping module 440 can correlate a series or combination of two or more poses/utterances made by the non-user to particular actions and sub-actions. For example, a detected waving pose of a non-user can activate pass-through for the non-user, while a subsequent detected pointing at an object can further activate pass-through for the object. Other exemplary actions that can be mapped to poses/utterances include opting into image capture by image capture module 436, opting out of image capture by image capture module 436, altering the XR content being displayed by XR content display module 434, establishing a communication channel with a device of the non-user, or any combination thereof. When establishing a communication channel with a device of the non-user, mapping module 440 can further map an identified pose (or a subsequent pose) to a type of content to share with the non-user's device or vice versa, such as the content being displayed by XR content display module 434. Further details regarding mapping poses to actions are described herein with respect to block 506 of FIG. 5.

Action execution module 442 can, responsive to pose identification module 438 identifying the pose/utterance of the non-user and mapping module 440 obtaining the mapped action to the pose/utterance, execute the mapped action on the XR device. For example, action execution module 442 can translate the identified pose of the non-user into a system-level or application-level command on the XR device, causing the XR device to perform the mapped action. Further details regarding executing a mapped action on an XR device in response to identifying a pose are described herein with respect to block 510 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for controlling an artificial reality (XR) device by a non-user of the XR device. In some implementations, process 500 can be performed as a response to detecting a non-user within the field-of-view of the XR device. In some implementations, process 500 can be performed as a response to activation or donning of the XR device by the user. In some implementations, process 500 can be performed upon execution of an XR application and/or XR experience on the XR device. In some implementations, process 500 can be performed in real time or near real time as images of real-world surroundings are captured and/or a pose of the non-user is identified.

In some implementations, functionality of process 500 can be performed by an XR system including one or more XR devices, e.g., an XR HMD (e.g., XR HMD 200 of FIG. 2A and/or XR HMD 252 of FIG. 2B), one or more external processing components, etc. In some implementations, functionality of process 500 can be performed by a cloud computing system and/or an edge computing system, e.g., block 506. In some implementations, process 500 can be performed by non-user controls system 164 of FIG. 1.

At block 502, process 500 can display XR content to a user of the XR device. In some implementations, the XR content can include virtual objects overlaid on a view of real-world surroundings of the XR device, such as in mixed reality (MR) or augmented reality (AR). In some implementations, the XR content can be a fully immersive, computer-generated environment, such as in virtual reality (VR). Process 500 can display the XR content by controlling lighting effects applied to the XR device to simulate three-dimensional (3D) virtual objects and/or a 3D environment on its display. In some implementations, however, it is contemplated that process 500 need not initially display XR content at block 502, and can instead begin by capturing images of the real-world surroundings of the XR device, as described herein with respect to block 504.

At block 504, process 500 can capture one or more images of real-world surroundings of the XR device. Process 500 can capture the images using one or more externally facing cameras (i.e., facing away from the user of the XR device) either integral with or in operable communication with the XR device. The one or more images can capture a non-user of the XR device, e.g., another person who is not using the XR device, but who may be using another device, such as another XR device, a mobile device, a wearable device, etc., as described further herein. In some implementations, process 500 can identify the non-user in the images by applying a kinematic model of a human body to the real-world environment, and identifying the various body parts of the non-user based on the kinematic model. Although described primarily herein as the non-user being a person, it is contemplated that the non-user can be another living or moveable object in some implementations, such as a pet or other animal, a moveable electronic device (e.g., a robotic device), etc., which can make particular poses (e.g., gazes, motions, etc.).

At block 506, process 500 can identify a pose of the non-user in the one or more images, and determine whether the pose in the one or more images is mapped to a predetermined action on the XR device. The pose can include particular hand and/or other body positions and/or movements made by the non-user. As noted above, process 500 can capture the pose via one or more cameras integral with or in operable communication with the XR device, such as cameras positioned on an XR device pointed away from the user's face. For example, process 500 can capture one or more images of the non-user's body in front of the XR device while making a particular pose. Process 500 can perform object recognition on the captured image(s) to identify a non-user's particular body parts making a particular pose (e.g., pointing, snapping, tapping, pinching, waving, giving a thumbs up, giving a thumbs down, etc.), alternatively or additionally to applying a kinematic model to the non-user to track skeletal movements. In some implementations, process 500 can identify a pose of the non-user in conjunction with one or more audible announcements, e.g., prolonged eye contact of the non-user with the XR device accompanied by an announcement of the XR device user's name.

In some implementations, process 500 can use a machine learning model to identify the pose from the image(s). For example, a machine learning model can be trained with images capturing known poses, such as images showing a non-user's hand making a fist, a non-user's finger pointing, a non-user making a sign with her fingers, a non-user placing her pointer finger and thumb together, a non-user turning her body away, etc., while facing an XR device or other externally facing camera. Process 500 can identify relevant features in the images, such as edges, curves, and/or colors indicative of fingers, a hand, an arm, etc., making a particular pose. The machine learning model can be trained using these relevant features of known poses. Once the model is trained with sufficient data, process 500 can use the trained model to identify relevant features in newly captured image(s) and compare them to the features of known poses. In some implementations, process 500 can use the trained model to assign a match score to the newly captured image(s), e.g., 80%. If the match score is above a threshold, e.g., 70%, process 500 can classify the motion captured by the image(s) as being indicative of a particular pose.

Once identified, process 500 can determine if the pose is mapped to a predetermined action by, for example, accessing a lookup table associating poses with particular actions that can be taken on the XR device. In some implementations, the mapping of the pose to the action can be dynamic based on a distance of the non-user from the XR device. For example, if the non-user is greater than a threshold distance from the XR device, the non-user shouting the user's name and waving his arms can be mapped to activating pass-through for the non-user. However, if the non-user is less than a threshold distance from the XR device, the non-user maintaining eye contact with the XR device and quietly speaking the user's name can be mapped to activating pass-through for the non-user. In other words, more pronounced gestures and/or announcements may be needed based on the XR device's fidelity in capturing the non-user's gesture's and/or announcements at a further distance than at a closer distance. In some implementations, the XR device can determine the distance of the non-user from the XR device based on his size in the one or more images, based on depth data captured by one or more depth sensors, etc. In other words, in some implementations, the action mapped to a given pose can be dynamic based on the distance between the XR device and the non-user. For example, the action mapped to the given pose can be a first action when the distance is above a threshold and the action mapped to the given pose can be a second action when the distance is below the threshold.

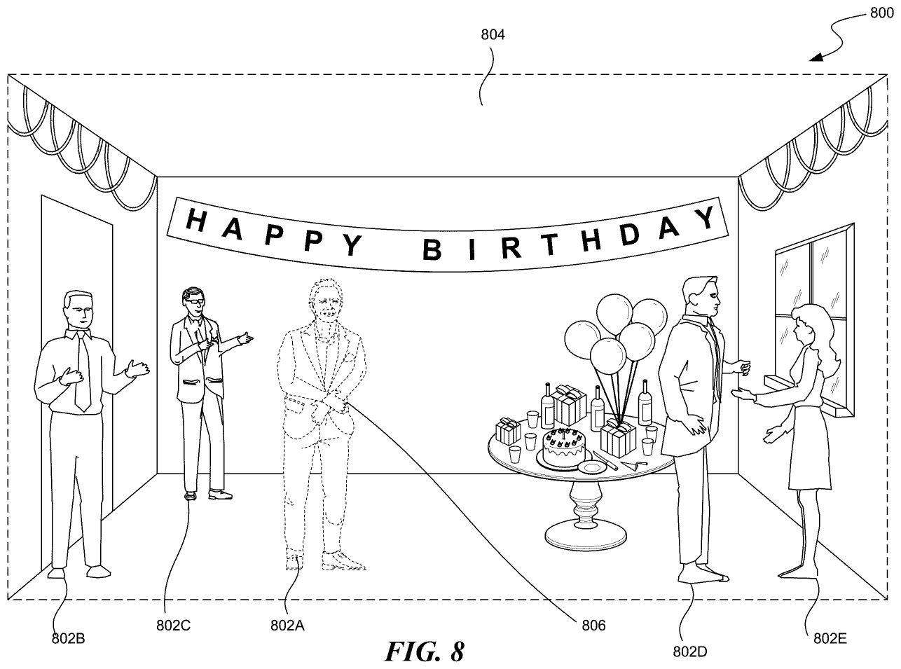

If a pose is not identified and/or the pose is not mapped to an action, process 500 can return to block 504, and continue capturing images of the non-user and/or the real-world surroundings of the XR device. If a pose is identified that is mapped to an action, process 500 can proceed to block 508. At block 508, process 500 can, responsive to identifying the pose of the non-user mapped to an action at block 506, execute the action on the XR device. In some implementations, the action can include opting into image capture by the XR device. For example, while in view of the XR device, the non-user can make a thumbs up gesture, which can be mapped to opting into future image capture, image display, and/or image storing of the non-user. In some implementations, the action can include opting out of image capture by the XR device. For example, the non-user can make a thumbs down, an “X” with his arms, and/or cover his face, which can be mapped to opting out of future image capture, image display, and/or image storing of the non-user. In some implementations, the XR device can then cease capturing images of the non-user, obscure the non-user in captured images, etc. An exemplary pose of a non-user being mapped to opting out of image capture is shown and described herein with respect to FIG. 8.

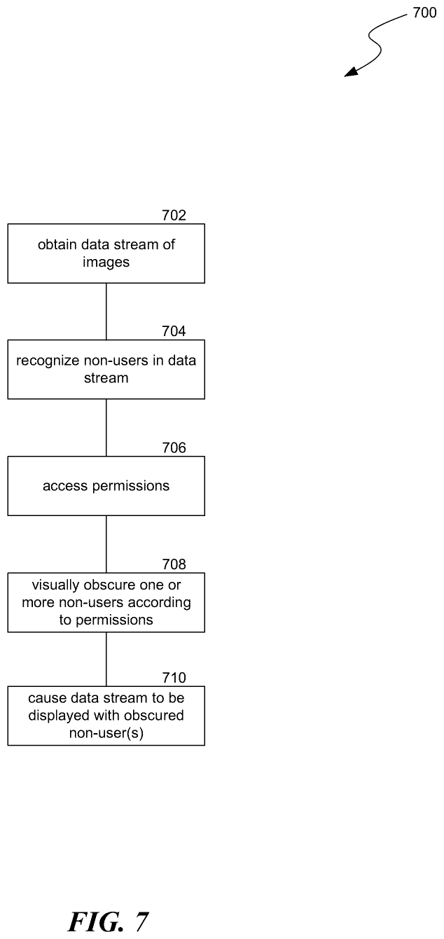

Although described herein as an “opt in” or “opt out” based on a pose of a non-user, it is contemplated that a non-user can opt in or out of image capture by the XR device through alternative or additional methods. For example, a non-user can opt in or out of image capture by making an audible announcement captured by one or more microphones integral with or in operable communication with the XR device, e.g., “OK to record me!” or “Don't record me!”, in conjunction with movement of the non-user's mouth consistent with speaking the phrase. The XR device can then transcribe and transform the audible announcement into a command for the XR device, e.g., continue capturing or stop capturing images of the particular non-user. In some implementations, alternative to ceasing capture of the non-user, process 500 can instead obscure the non-user in the captured images, e.g., by applying a degradation (e.g., blurring, inpainting the non-user in the images such that only a silhouette appears, etc.), as described further herein with respect to FIGS. 7 and 8.

In some implementations, process 500 can alternatively or additionally determine whether a non-user has opted into or opted out of image capture by the XR device by accessing a platform computing system with which the non-user has preregistered. For example, the non-user can set his preferences for image capture, the capture being performed by the XR device of the user, XR devices of certain other users, and/or other XR devices in general, via a social media platform. In such implementations, the platform computing system can perform facial recognition on the captured images to identify the non-user, then access the non-user's preferences to determine whether the non-user has opted into or out of image capture by the XR device via a pre-registration. Using similar methods, it is contemplated that the platform computing system can identify a non-user captured by the XR device after image capture (e.g., in near real time, 2 hours later, a day later, etc.), and proactively contact the non-user to request permission for the XR device to retain the images of the non-user, either in their initially captured state or in a degraded form (e.g., with the non-user blurred out).

In some implementations, the action can include activating pass-through on the XR device while the user is executing a VR experience. In some implementations, the action can include activating pass-through for the entire display, such that the user sees her real-world surroundings including the non-user. In some implementations, the action can include activating pass-through for the portion of the display corresponding to the non-user. For example, the non-user can approach the XR device and wave at the user, as captured by one or more cameras on the XR device. Such an action can cause the XR device to display her body through pass-through, while still displaying a VR experience on the remainder of the display.

In some implementations, the action (e.g., mapped XR device action) can include activating pass-through for a portion of the display corresponding to a real-world object. For example, the non-user can frame the screen of her mobile phone with an “L” shape of her hand and/or gesture with the mobile phone (e.g., move side-to-side, shake, etc.), as captured by one or more cameras on the XR device. Such an action can cause the XR device to display the mobile phone through pass-through, while still displaying a VR experience on the remainder of the display. In some implementations, the XR device can selectively trigger pass-through for any object relative to which the user performs a predefined gesture (e.g., shake, move from side-to-side, frame with hand(s), etc.). In some implementations, a larger or more pronounced or exaggerated gesture by the non-user can activate pass-through for a larger portion of the display of the XR device corresponding to one or more real-world objects.

In some implementations, the action (e.g., mapped XR device action) can include altering the XR content displayed to the user of the XR device. For example, in an MR or AR experience, the XR device can display virtual objects overlaid on and/or around a view of the real-world surroundings, including a view of the non-user. Based on one or more poses or movements of the non-user, process 500 can alter the XR content being displayed. For example, based on detection of the non-user walking around the real-world surroundings, process 500 can move virtual objects relative to the non-user such that collisions do not occur on the display.

In some implementations, the action (e.g., mapped XR device action) can include establishing a communication channel between the XR device and another device of the non-user. For example, a non-user can gesture toward her own device, as detected by one or more cameras integral with or in operable communication with the XR device. Based on identification of the pose, process 500 can establish a link between the XR device and the non-user's device, e.g., a Bluetooth connection, a Near Field Communication (NFC) connection, a connection over network 330 of FIG. 3, etc. Once the communication channel is established, process 500 can share data with the non-user's device, such as sharing a two-dimensional (2D) rendering of the content displayed on the XR device (when the non-user's device is a 2D interface, such as a computer, a mobile phone, a tablet, a television, etc.), sharing a three-dimensional (3D) rendering of the content displayed on the XR device (when the non-user's device is an XR device), sharing a particular type of content (e.g., social media content), etc. In some implementations, the type of content shared with the non-user's device can be based on the particular pose made by the non-user or a subsequently detected pose. In some implementations, the type of content shared with the non-user's device can be based on capabilities of the non-user's device and/or the communication channel as determined once the communication link is established. For example, if the non-user's device is not an XR device, if the non-user's device has low battery power, if the network latency is poor, etc., process 500 can share a 2D and/or textual rendering of content.

In some implementations, prior to the action being executed, immediately after the action is executed, or while the action is being executed, process 500 can activate an alert on the XR device indicating that the action will be, was, or is being executed. For example, process 500 can generate audible feedback indicating that the action will be or was executed, e.g., through one or more speakers integral with or in operable communication with the XR device. For example, process 500 can initiate a predefined communication flow and/or use a chat bot to engage the non-user in a natural language discussion to confirm that the action should be executed or was executed. In another example, process 500 can activate one or more lights (e.g., one or more LEDs) positioned externally on the XR device, e.g., facing the non-user.

In some implementations, process 500 can receive feedback from the user of the XR device regarding whether the identification of the pose was correct at block 506, and update the trained model accordingly. For example, as described further herein with respect to block 508, process 500 can execute an action corresponding to the identified pose, and the user of the XR device or the non-user can provide feedback regarding the prediction, which can be implicit or explicit. For example, the user or non-user of the XR device can execute a different action than that corresponding to the predicted pose, which may indicate that the predicted pose was incorrect. In another example, the user or non-user of the XR device can fail to execute a different action than that corresponding to the predicted pose, which may indicate that the predicted pose was correct. In still another example, the user or the non-user of the XR device can audibly announce that the corresponding action was incorrect, and/or identify what the correct action was. However, it is contemplated that the user of the XR device correcting or not correcting an executed action may not, in some implementations, be indicative of whether the predicted pose was incorrect, and can instead indicate that the user did not want the particular action caused by the pose to occur.

Although illustrated in FIG. 5 as being performed once, it is contemplated that process 500 can be performed repeatedly, either concurrently or consecutively, and/or multiple iterations of process 500 can be performed in parallel. For example, in some implementations, multiple iterations of process 500 can be performed for each of multiple non-users captured by the XR device, which can cause execution of multiple different actions. Further, it is contemplated that, in some implementations, poses made by different non-users can be complementary instead of mutually exclusive. For example, process 500 can perform a first action based on a first non-user's pose, and take the same or a different action, sub-action of the first action, etc., based on a second non-user's pose.

In some implementations, process 500 can identify pose(s) by multiple non-users as a group pose. For example, a first non-user may perform a gesture that maps to a XR device action to take a photo of the non-user. The XR device may identify other non-users adjacent to the first non-user to capture in the photo, such as non-users that perform an “opt in” gesture, non-users that are smiling at the XR device proximate to the time that the first non-user performs the gesture, non-users whose actions indicate a desire to be part of the photo (e.g., putting an arm around the first non-user or an “opted in” non-user), etc. These “opt in” gesture(s) and/or actions by the other non-users can be considered part of a group pose in combination with the gesture by the first non-user. In this example, the mapped action can be capturing a photo by the XR device of a group of non-users that includes the first non-user and the other non-users adjacent to the first non-user that “opt in” to the photo or that are otherwise determined to be part of the group pose that triggered the photo.

A “machine learning model,” as used herein, refers to a construct that is trained or configured using data set(s) (e.g., training data) to make predictions or provide probabilities for new data items, whether or not the new data items were included in the data set(s). For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include: neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the machine learning model can be a neural network with multiple input nodes that receive data about non-user poses or movements. The input nodes can correspond to functions that receive the input and produce results. These results can be provided to one or more levels of intermediate nodes that each produce further results based on a combination of lower level node results. A weighting factor can be applied to the output of each node before the result is passed to the next layer node. At a final layer, (“the output layer,”) one or more nodes can produce a value classifying the input. In some implementations, such neural networks, known as deep neural networks, can have multiple layers of intermediate nodes with different configurations, can be a combination of models that receive different parts of the input and/or input from other parts of the deep neural network, or are convolutions or recurrent-partially using output from previous iterations of applying the model as further input to produce results for the current input.

A machine learning model can be trained with supervised learning, where the training data includes non-user poses or movements as input and a desired output, such as an identified pose. A representation of body positions or movements of the non-user can be provided to the model. Output from the model can be compared to the desired output for that input and, based on the comparison, the model can be modified, such as by changing weights between nodes of the neural network or parameters of the functions used at each node in the neural network (e.g., applying a loss function). After applying the input in the training data and modifying the model in this manner, the model can be trained to evaluate new data. Similar training procedures can be used for the various machine learning models discussed above.

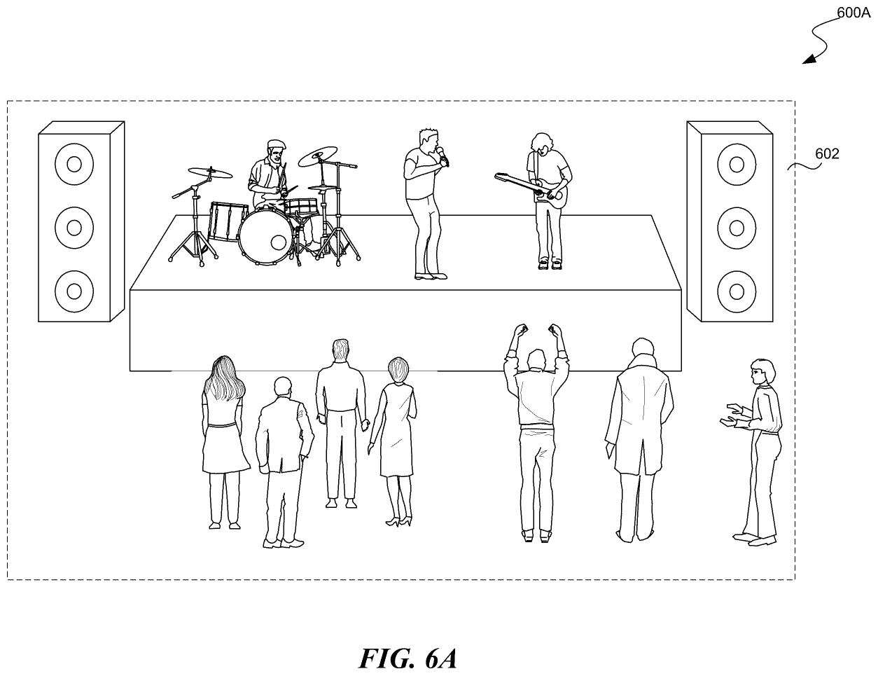

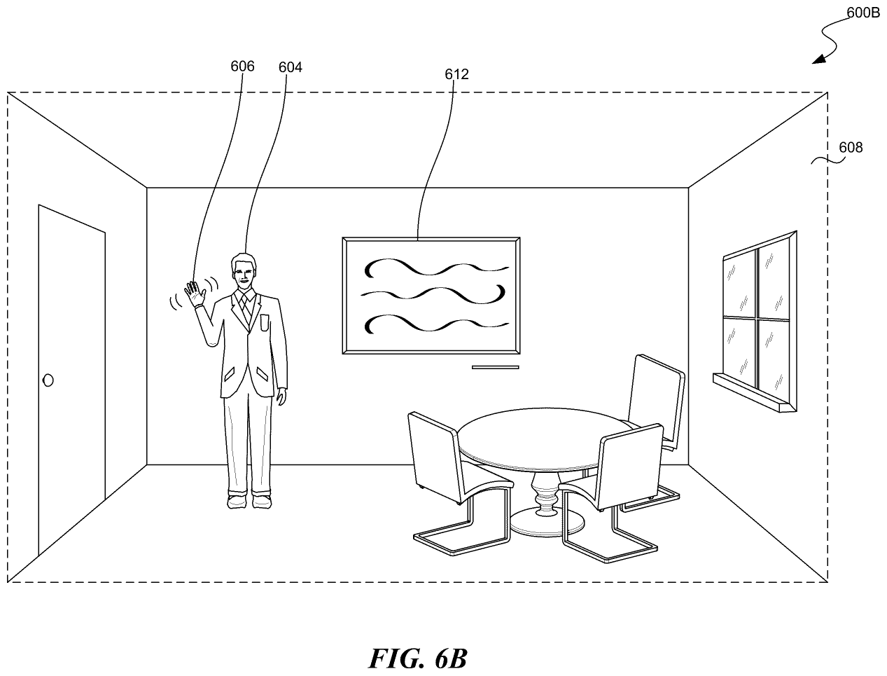

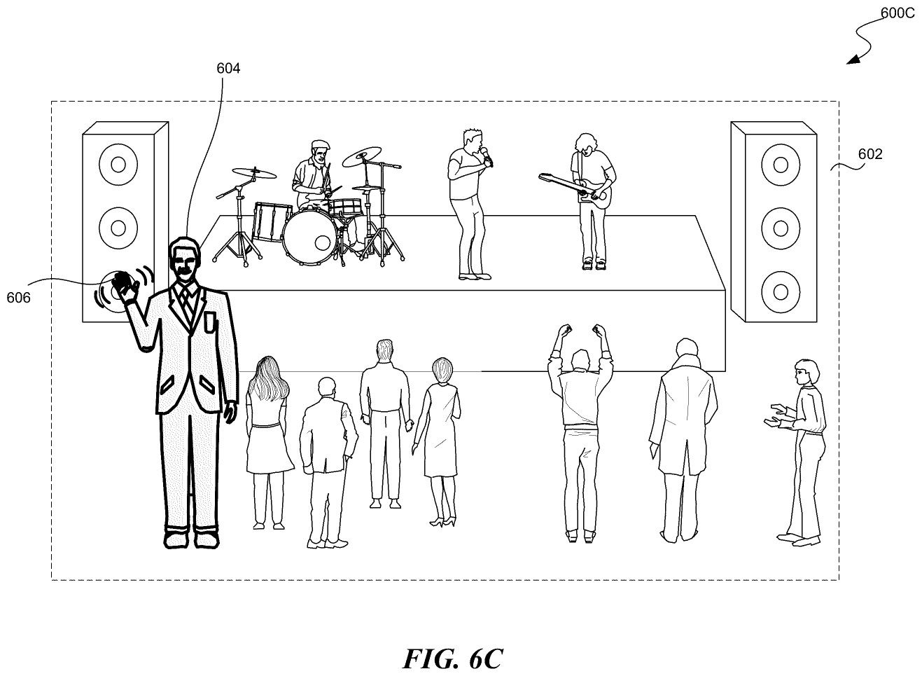

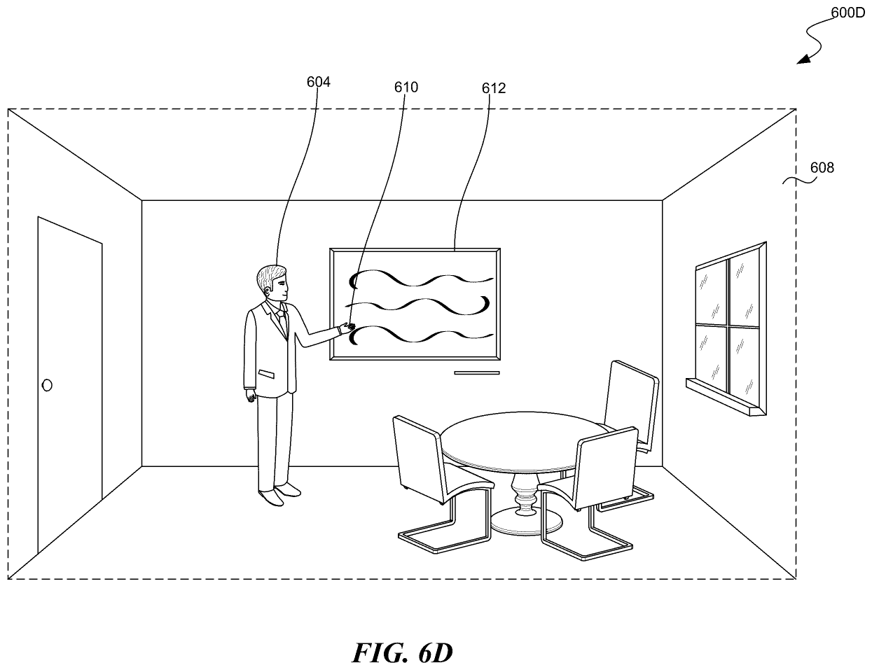

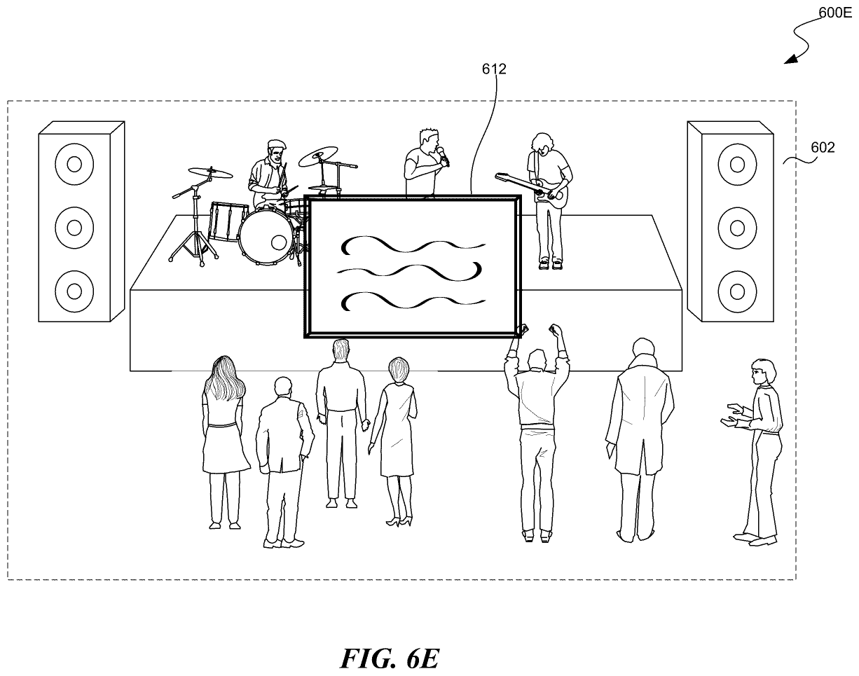

FIG. 6A is a conceptual diagram illustrating an example view 600A on an artificial reality (XR) device, with no pass-through view of a real-world environment. View 600A includes VR experience 602. VR experience 602 is displayed on approximately 100% of the XR device's display.

FIG. 6B is a conceptual diagram illustrating an example view 600B, from a position of an artificial reality (XR) device and captured by the XR device, of a non-user 604 making a pose 606 mapped to activation of pass-through for the non-user 604 on the XR device. Non-user 604 can make pose 606 (e.g., waving his hand) in real-world environment 608, within the field of view of the XR device, which can be captured by one or more cameras on the XR device while the user of the XR device has view 600A of FIG. 6A. The XR device can recognize pose 606 by, for example, applying a kinematic model to non-user 604 and tracking his skeletal movements relative to the kinematic model. In another example, the XR device can recognize pose 606 by applying a machine learning model trained to recognize particular gestures made by non-users within the field of view of the XR device, as described further herein.

FIG. 6C is a conceptual diagram illustrating an example view 600C on an artificial reality (XR) device of a non-user 604 being displayed in pass-through in response to an identified pose 606 of the non-user 604. Based on identification of pose 606 by the XR device via cameras capturing view 600B of FIG. 6B, the XR device can activate selective pass-through for non-user 604 (as indicated by bolded lines around non-user 604 indicating an area of pass-through), which can be mapped to pose 606 of non-user 604. Thus, the user of the XR device can have view 600C, in which a pass-through view of the non-user is seen, while VR experience 602 continues to display on the remainder of the XR device. In some implementations, VR experience 602 can be paused while the selective pass-through is active, or VR experience 602 can continue executing during activation of the selective pass-through.

In some implementations, the XR device can recognize the body of non-user 604 by applying a kinematic model to non-user 604. In some implementations, the XR device can use a machine learning and/or deep learning model to perform object recognition and/or detection in the real-world environment to identify the non-user. The XR device can train the model based on known images of people, e.g., faces, bodies, body parts, etc. In some implementations, the XR device can identify features in the known images, e.g., corresponding to edges, corners, and other unique and/or identifying features. The XR device can then receive the input image (e.g., view 600B of FIG. 6B), extract features in objects present in the image, and compare the extracted features to the identified features in the known images to identify the non-user for whom pass-through should be activated with some degree of certainty.

FIG. 6D is a conceptual diagram illustrating an example view 600D, from a position of an artificial reality (XR) device and captured by the XR device, of a non-user 604 making a pose 610 mapped to activation of pass-through for a real-world object 612 (e.g., a whiteboard) on the XR device. Non-user 604 can make pose 610 (e.g., gesturing toward object 612) within the field of view of the XR device, which can be captured by one or more cameras on the XR device while the user of the XR device has view 600A of FIG. 6A. The XR device can recognize pose 610 by, for example, applying a kinematic model to non-user 604 and tracking his skeletal movements relative to the kinematic model. In another example, the XR device can recognize pose 610 by applying a machine learning model trained to recognize particular gestures made by non-users within the field of view of the XR device, as described further herein.

FIG. 6E is a conceptual diagram illustrating an example view 600E on an artificial reality (XR) device of a real-world object 612 being displayed in pass-through in response to an identified pose 610 of a non-user. Based on identification of pose 610 by the XR device via cameras capturing view 600D of FIG. 6D, the XR device can activate selective pass-through for object 612 (as indicated by bolded lines corresponding to the pass-through area), which can be mapped to pose 610 of non-user 604. Thus, the user of the XR device can have view 600E, in which a pass-through view of object 612 is seen, while VR experience 602 continues to display on the remainder of the XR device.

In some implementations, the XR device can identify the location of object 612 based on pose 610, i.e., where pose 610 is performed relative to object 612. The XR device can further identify the type of object 612 and/or the bounds of object 612 using object recognition and/or object detection techniques, e.g., as applied by a machine learning model and/or deep learning model trained on physical objects and/or boundaries of physical objects. In some implementations, the XR device can identify features in the known objects, e.g., corresponding to edges, corners, and other unique and/or identifying features. The XR device can then receive an input image captured by the XR device (e.g., view 600D of FIG. 6D), extract features in objects present in the image, and compare the extracted features to the identified features in the known objects and/or the boundaries of known objects to identify and/or detect the objects.

FIG. 7 is a flow diagram illustrating a process 700 used in some implementations for obscuring a non-user in a data stream of images. In some implementations, process 700 can be used to control the storing and/or streaming of non-user images captured by an XR device associated with a user. In some implementations, process 700 can be triggered by capturing one or more images of a non-user. In some implementations, one or more steps of process 700 can be performed by an XR system including one or more XR devices, e.g., an XR HMD, one or more external processing components, etc., obtaining and/or capturing images of a non-user. In some implementations, one or more steps of process 700 can be performed on a platform computing system located remotely from the XR system, e.g., a cloud system and/or edge system.

At block 702, process 700 can obtain a data stream. For example, one or more image capturing devices (e.g., cameras) of an XR device can capture image data in a field of view that includes several objects in a real-world environment. At block 704, process 700 can recognize and categorize objects within the data stream. For example, one or more machine learning models can be trained and/or configured to recognize non-users and categorize the non-users in the obtained data stream, e.g., along with an identifier of the non-user.

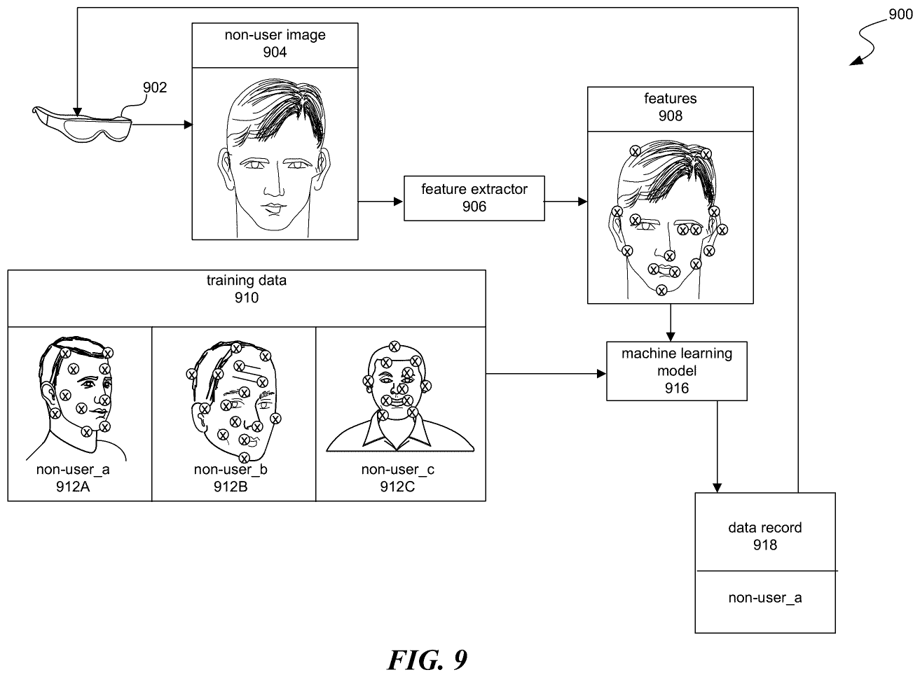

In some implementations, process 700 can identify the non-users by performing facial recognition on the captured image data by comparing the facial images to preexisting facial images of known people. Process 700 can obtain the facial images of known people, for example, through the XR device user's photographs, through social media accounts (e.g., the XR device user's connections), and/or through a publicly available database of images of known people. Further details regarding performing facial recognition are described herein with respect to FIG. 9. In some implementations, however, process 700 can identify the non-users by the non-users identifying themselves and/or by the XR device's user identifying the non-users (e.g., through an audible announcement of the non-users' names).

At block 706, process 700 can access non-user permissions that include non-user capturing and/or storing rules. For example, process 700 can access a contact list stored on the XR device to determine whether the identified non-users have previously opted into or out of image capture by the XR device (e.g., via a platform computing system, by performing an “opt in”/“opt out” gesture or announcement as described herein, etc.). In another example, process 700 can query a third-party website or application (e.g., a social media platform) to determine whether the identified non-users have previously opted into or out of image capture by the XR device.

In some implementations, the non-user capturing rules can define: specific non-users and the display, sharing, and/or image storing status for these specific non-users, a non-user location (e.g., within or outside a predefined region) and the display status for the non-user location, a list of permitted non-users (e.g., allowlist) with specific definitions, a list of restricted non-users (e.g., blocklist) with specific definitions, display status for people (e.g., specific recognized faces using facial recognition, unrecognized faces, etc.), and any other suitable rules. The recognized and categorized non-users can be compared to the non-user rules and one or more of the non-users can be obscured when the non-user category, non-user location, or other suitable parameter matches a rule that states the non-user should be obscured.

At block 708, process 700 can visually obscure non-users based on the non-user capturing rules. For example, at least one non-user can match a rule that defines the non-user should be obscured from saved or shared images. One or more machine learning models can be trained/configured to track the non-user while the data stream of images is being captured (e.g., masking out portions of video frames corresponding to the identified non-users) and a blocking object, filter, mask, or other suitable obscuring element can be generated in place of or over the object. In some implementations, one or more faces of non-users can be obscured from the data stream of images. In some implementations, process 700 can crop the non-users from the data stream of images.

At block 710, process 700 can cause the data stream of images to be displayed with the obscured non-users. For example, the XR device can display images of the real-world environment with at least the faces (if not the entire bodies) of the blocked non-users being blurred, being filled in with color, being filled in with noise, blocked with a virtual object, and/or otherwise making the non-users unrecognizable and/or unidentifiable. Thus, the XR device does not retain images of the real-world environment including the non-users who have opted out of image capture, and/or does not share images of the real-world environment including such non-users, unless they are removed or obscured.

FIG. 8 is a conceptual diagram illustrating an example view 800 on an artificial reality (XR) device of a non-user 802A being obscured based on an image capture opt-out process by the non-user 802A. While traversing real-world environment 804, the user of the XR device can capture one or a series of images of real-world environment 804, including non-users 802A-E. Upon detection of non-users 802A-E, the XR device can perform one or more processes to determine that non-user 802A has opted out of image capture. For example, the XR device can identify pose 806 of non-user 802A (e.g., making an “X” with his arms), which can be mapped to opting out of image capture.

In another example, the XR device can identify non-user 802A based on, for example, identifying facial features as compared to facial features of known people (e.g., indicated in previously captured images or connections from a user's social graph, etc.), an audible identification made by non-user 802A or the XR device's user, etc. The XR device can then determine that the XR device does not have permission to capture non-user 802A, e.g., from a list of permissions associated with non-user 802A on a social media platform, as previously established with the XR device, etc. In some implementations, the XR device can similarly determine that non-users 802B-E have opted into image capture. Alternatively, the XR device can capture non-users 802B-E based on such users not explicitly opting out of image capture. Still alternatively, the XR device can capture only non-users 802B-E that have explicitly opted in, and obscure non-user 802A based on him not explicitly opting into image capture.

As indicated by the dashed lines in view 800, images of non-user 802A can be degraded or obscured. For example, images of non-user 802A can have him blurred out or otherwise captured or rendered in low quality, filled in with a solid color, obscured with a virtual object, etc. In another example, images of non-user 802A can be cropped to exclude non-user 802A (not shown). In still another example, the XR device can cease capturing images while non-user 802A is detected in its field of view. In some implementations, the degraded or obscured images of non-user 802A can be displayed on the XR device. In some implementations, the degraded or obscured images can be stored, while the original, unaltered images are not stored. Thus, only the degraded or obscured images can later be accessed, displayed, and/or shared, thereby maintaining non-user 802A's privacy.

FIG. 9 is a conceptual diagram illustrating an exemplary flow 900 for non-user facial recognition according to some implementations of the present technology. In some implementations, flow 900 can be performed as a response to capturing non-user image 904. In some implementations, flow 900 can be performed by XR device 902 and/or one or more other XR devices in an XR system, such as one or more external processing components. In some implementations, flow 900 can be performed by a central computing system, such as a cloud computing system and/or an edge computing system.

XR device 902 can capture non-user image 904, e.g., using a camera integral with XR device 902 and pointed away from the user of XR device 902. In some implementations, XR device 902 can capture at least a pass-through view of a real-world environment, such as in mixed reality (MR) or augmented reality (AR). In some implementations, however, XR device 902 can provide a fully immersive, computer-generated three-dimensional (3D) environment for the user of the XR device, while still capturing external images, e.g., non-user image 904.

Non-user image 904 can be fed into feature extractor 906 that can identify relevant features 908 in non-user image 904. The relevant features can correspond to, for example, edges, corners, shapes, curvatures, colors, textures, lighting, etc. In some implementations, the relevant features can include the positions and locations of edges, corners, curvatures, colors, etc., corresponding to particular facial feature. Features 908 can be fed into machine learning model 916. In some implementations, non-user image 904 can also fed into machine learning model 916.

Machine learning model 916 can obtain training data 910 including labeled images of non-users with identified features; for example, historical image 912A of the non-user in user image 904 (e.g., “non-user_a”), historical image 912B of another user (e.g., “non-user_b”), and historical image 912C of still another user (e.g., non-user_c). Historical images 912A-C can be obtained from, e.g., a social media platform, photographs stored on XR device 902 or on a cloud (e.g., previously captured images of identified users), etc. Although illustrated as including three historical images 912A-C, it is contemplated that training data 910 can include any number of historical images of any number of one or more non-users.

Machine learning model 916 can compare features 908 to training data 910 to determine a match score between features 908 and training data 910. In this case, machine learning model 916 can determine that features 908 match the features of “non-user_a” in historical image 912A above a threshold match score, e.g., 85%. Machine learning model 916 can output data record 918 indicating that the facial features identified in non-user image 904 correspond to “non-user_a” in historical image 912A.

In some implementations, data record 918, or any derivative thereof, can be used by XR device 902 (or a central computing system) to determine whether “non-user_a” has opted into or out of image capture by XR device 902, or has neither opted in nor opted out. Based on this determination, XR device 902 can continue capturing and/or storing images of “non-user_a,” can cease capturing and/or storing images of “non-user_a,” can obscure “non-user_a” in captured images, can crop “non-user_a” from captured images, etc., as described further herein. In some implementations, data record 918, or any derivative thereof, can be displayed in any suitable means on XR device 902, such as textually. In some implementations, the user of XR device 902 can provide feedback on whether the predicted non-user is correct or incorrect.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations exclusive of mutually other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/we claim:

1. A method for controlling an artificial reality (XR) device by a non-user of the XR device, the method comprising:
displaying XR content to a user of the XR device;
capturing, by the XR device, one or more images of real-world surroundings of the XR device, wherein the one or more images capture the non-user of the XR device;
identifying a pose of the non-user in the one or more images, the pose being mapped to an action on the XR device; and
responsive to identifying the pose of the non-user, executing the action on the XR device, wherein the action comprises one or more of: opting into image capture by the XR device, opting out of image capture by the XR device, activating pass-through on the XR device, altering the XR content displayed to the user of the XR device, establishing a communication channel between the XR device and an other device of the non-user, or any combination thereof.

2. The method of claim 1, wherein the identified pose is a motion made by the non-user.

3. The method of claim 1,
wherein the XR content is virtual reality (VR) content,
wherein the action is activating pass-through for the non-user on the XR device, and
wherein the method further comprises:
transitioning display of the VR content to pass-through on the XR device.

4. The method of claim 1,
wherein the action is activating pass-through on the XR device, and
wherein pass-through is activated for a real-world object, in the real-world surroundings, indicated by the pose of the non-user.

5. The method of claim 1,
wherein the action is establishing a communication channel between the XR device and an other device of the non-user,
wherein the pose of the non-user is further mapped to the XR content displayed on the XR device, and
wherein the method further comprises:
sharing, via the communication channel, a version of the XR content with the other device of the non-user based on the pose of the non-user, the version of the XR content being rendered by the other device of the non-user.

6. The method of claim 1,
wherein the action is opting out of image capture by the XR device, and
wherein the method further comprises:
capturing one or more additional images of the non-user; and
applying a degradation to the one or more additional images in an area corresponding to the non-user.

7. The method of claim 6, wherein the degradation is blurring or inpainting.

8. The method of claim 1,
wherein the action is opting out of image capture by the XR device, and
wherein the method further comprises:
pausing capture of the one or more images of the non-user while the non-user is within view of the XR device.

9. The method of claim 1,
wherein the identified pose is accompanied by an audible announcement made by the non-user, and
wherein executing the action on the XR device is further in response to detection of the audible announcement.

10. The method of claim 1, further comprising:
activating an alert, on the XR device, indicating that the action was executed on the XR device, the alert including at least one of audible feedback, visual feedback, or both, to the non-user.

11. The method of claim 1, further comprising:
determining a distance between the XR device and the non-user, wherein the action mapped to the pose is dynamic based on the distance such that the mapped action comprises a first action when the distance is above a threshold and the mapped action comprises a second action when the distance is below the threshold.

12. A computer-readable storage medium storing instructions that, when executed by a computing system, cause the computing system to perform a process for controlling an artificial reality (XR) device by a non-user of the XR device, the process comprising:
capturing, by the XR device, one or more images of real-world surroundings of the XR device, wherein the one or more images capture the non-user of the XR device;
identifying a pose of the non-user in the one or more images, the pose being mapped to an action on the XR device; and
responsive to identifying the pose of the non-user, executing the action on the XR device, wherein the action comprises one or more of: opting into image capture by the XR device, opting out of image capture by the XR device, activating pass-through on the XR device, altering XR content displayed to a user of the XR device, establishing a communication channel between the XR device and an other device of the non-user, or any combination thereof.

13. The computer-readable storage medium of claim 12,
wherein the action comprises activating pass-through on the XR device, and
wherein the process further comprises:
transitioning from displaying virtual reality (VR) content to pass-through for at least a portion of a display of the XR device.

14. The computer-readable storage medium of claim 13,
wherein the at least the portion of the display corresponds to a real-world object, in the real-world surroundings, indicated by the pose of the non-user.

15. The computer-readable storage medium of claim 12,
wherein the action is establishing a communication channel between the XR device and an other device of the non-user,
wherein the pose of the non-user is further mapped to XR content displayed on the XR device, and
wherein the process further comprises:
sharing, via the communication channel, a version of the XR content with the other device of the non-user based on the pose of the non-user, the version of the XR content being rendered by the other device of the non-user.

16. A computing system for controlling an artificial reality (XR) device by a non-user of the XR device, the computing system comprising:
one or more processors; and
one or more memories storing instructions that, when executed by the one or more processors, cause the computing system to perform a process comprising:
capturing, by the XR device, one or more images of real-world surroundings of the XR device, wherein the one or more images capture the non-user of the XR device;
identifying a pose of the non-user in the one or more images, the pose being mapped to an action on the XR device; and
responsive to identifying the pose of the non-user, executing the action on the XR device, wherein the action comprises one or more of: opting into image capture by the XR device, opting out of image capture by the XR device, activating pass-through on the XR device, altering XR content displayed to a user of the XR device, establishing a communication channel between the XR device and an other device of the non-user, or any combination thereof.

17. The computing system of claim 16,
wherein the action is opting out of image capture by the XR device, and
wherein the process further comprises:
capturing one or more additional images of the non-user; and
applying a degradation to the one or more additional images in an area corresponding to the non-user.

18. The computing system of claim 16,
wherein the action is opting out of image capture by the XR device, and
wherein the process further comprises:
pausing capture of the one or more images of the non-user while the non-user is within view of the XR device.

19. The computing system of claim 16, wherein the process further comprises:
activating an alert, on the XR device, indicating that the action was executed on the XR device, the alert including at least one of audible feedback, visual feedback, or both, to the non-user.

20. The computing system of claim 16, wherein the process further comprises:
determining a distance between the XR device and the non-user, wherein the action mapped to the pose is dynamic based on the distance such that the mapped action comprises a first action when the distance is above a threshold and the mapped action comprises a second action when the distance is below the threshold.
